(19) United States
(12) Patent Application Publication
(10) Pub. No.: US 2026/0161683 A1
(43) Pub. Date: Jun. 11, 2026

(54) DYNAMIC CONTEXT WINDOW MANAGEMENT FOR CONVERSATIONAL AI AGENTS

(71) Applicant: Twilio Inc., San Francisco, CA (US)

(72) Inventors: Christopher Lintz, Franktown, CO (US); Brian Partridge, Austin, TX (US)

(21) Appl. No.: 19/179,428

(22) Filed: Apr. 15, 2025

Related U.S. Application Data
(60) Provisional application No. 63/634,311, filed on Apr. 15, 2024.

(51) Int. Cl. G06F 16/3329; H04L 51/216

(52) U.S. Cl. CPC G06F 16/33295; H04L 51/216

(57) ABSTRACT

A method for managing conversation history in an AI system is disclosed. A user message is received and full conversation history payload is retrieved from a memory service. The full conversation history payload includes one or more messages, summaries, or moments. A prompt budget is dynamically allocated based on an available context window. The prompt budget determines token allocations for the messages, summaries, or moments from the full conversation history payload. A prompt is assembled for a language model by selecting conversation history elements to fit within the allocated prompt budget. The selecting balances between recent verbatim messages, summarized content of older messages, and relevant older moments. The prompt budget is iteratively adjusted and the prompt is iteratively reassembled as new information is added from one or more language model outputs or tool calls, while maintaining the full conversation history payload in the memory service.

### RELATED APPLICATIONS

This application claims the benefit of U.S. Provisional Application No. 63/634,311, filed Apr. 15, 2024, which is incorporated by reference herein in its entirety.

### TECHNICAL FIELD

The disclosed subject matter generally relates to memory management in conversational artificial intelligence (AI) agents or systems and, more specifically, to techniques for dynamically optimizing context window allocation and conversation history management in AI-driven communication systems that maintain extended dialogues across multiple channels while balancing token budgets, computational resources, and conversation quality within a distributed network environment. The subject matter described in the application particularly focuses on per-prompt dynamic adjustment of token budgets that determines the optimal mix of verbatim messages, summarized conversation history, and relevant historical moments to include in each prompt sent to large language models (LLMs), while adapting to changing context requirements as new information is added from language model outputs or tool calls.

### BACKGROUND

Advancements in natural language processing (NLP) and machine learning have given rise to AI agents capable of engaging in dynamic, human-like conversations. These AI agents leverage large language models (LLMs), a subset of generative language models, to process user input and generate meaningful responses. By utilizing deep learning techniques and vast amounts of training data, LLMs enable AI agents to understand and generate text with remarkable fluency and contextual awareness. As a result, conversational AI agents are now widely used in applications such as virtual assistants, chatbots, customer support systems, and content generation platforms.

A fundamental aspect of the operation of an AI agent is its context window, which functions as the working memory for processing and generating responses. The context window is a fixed-length segment that contains all the relevant information the AI agent considers when producing an output. This typically includes user inputs, which are the messages or queries submitted by the user during an interaction. It also includes system instructions that define operational guidelines and constraints, ensuring that the AI agent responds in a controlled and structured manner. Additionally, the context window retains a record of the recent conversation history, allowing the AI agent to maintain continuity by referencing previous exchanges. The AI agent's own generated outputs are also written back into the context window, ensuring that it can build upon past responses and sustain an ongoing dialogue.

To maintain a coherent and contextually aware conversation, the AI agent continuously updates and manages the context window as the interaction progresses. Each new user message is incorporated into the window, and every newly generated response is appended to preserve the flow of conversation. This iterative process allows the AI agent to track and respond to user interactions in a way that reflects prior exchanges, creating a seamless and contextually relevant experience. By systematically managing the context window, the AI agent ensures that its responses remain informed and meaningful within the scope of an ongoing conversation.

### BRIEF DESCRIPTION OF THE DRAWINGS

Some embodiments are illustrated by way of example and not limitation in the figures of the accompanying drawings.

FIG. 1 is a block diagram illustrating a context window structure for a conversational AI system, showing the relationship between prompt components, and a generative language model.

FIG. 2 is a block diagram depicting a high-level architecture of an AI system with dynamic prompt generation capabilities, illustrating the interaction between a user device, AI agent, and generative language model, consistent with some embodiments.

FIG. 3 is a block diagram depicting a memory management architecture for conversational AI, showing the relationships between user device, AI agent, conversation router, memory service, and other system components, consistent with some embodiments.

FIG. 4-A is a sequence diagram illustrating the first part of a method for dynamically managing conversation history in an AI system, showing token budget allocation and context window optimization during initial message processing and tool usage, according to one example.

FIG. 4-B is a sequence diagram illustrating the second part of the method for dynamically managing conversation history, showing continued token budget reallocation and final response generation, according to the example.

FIG. 5 is a block diagram illustrating a software architecture that may be installed on a machine, according to an example embodiment.

FIG. 6 is a block diagram illustrating components of a machine able to read instructions from a machine-readable medium and perform any of the methodologies discussed herein, according to an example embodiment.

### DETAILED DESCRIPTION

Disclosed herein are techniques for dynamically managing conversation history in artificial intelligence (AI) systems, particularly focusing on optimizing context window usage for extended dialogues. The system addresses the technical challenges associated with maintaining context over long-term conversations while balancing computational efficiency, cost considerations, and response quality. By implementing an intelligent approach to memory management, the system dynamically allocates token budgets within available context windows, strategically selecting between message, (e.g., recent, possibly verbatim, messages), summaries, (e.g., summarized older or historical content), and moments (e.g., relevant historical or past moments). Moments may generally be select and summarized portions of prior messages that are part of the same or a different AI agent-facilitated conversation and may include metadata of the conversation history. For example, the moments may include text metadata (e.g., a date/time, category, chat or conversation metadata, messaging metadata, email metadata) or audio metadata (e.g., title, category, transcribed voice, call details). The metadata may include one or more of the following: descriptive metadata, structural metadata, administrative metadata. The adaptive methodology set forth herein enables AI agents to maintain coherent, contextually relevant conversations across multiple communication channels despite the inherent limitations of fixed context windows in large language models (LLMs). The system continuously recalculates the prompt budget and reassembles the prompt as new information is added—whether from language model outputs or external tool calls—while preserving the full conversation history in a dedicated memory service. The memory service maintains both raw verbatim messages and summarized content, allowing the AI agent to make optimal decisions about which elements to include in each prompt based on the available token space. This per-prompt dynamic adjustment ensures that even as the context window becomes constrained by tool responses or other new information, the system can still provide the most relevant context to the language model for generating high-quality responses. In the following description, numerous implementation details are provided regarding the dynamic token allocation process, memory service architecture, and channel-specific optimizations, though it will be apparent that various modifications may be implemented without departing from the principles described herein.

Conversational AI systems have evolved rapidly in recent years, enabling more natural and extended interactions between humans and AI agents or AI assistants. However, these systems face a fundamental technical challenge: maintaining context over long-term conversations while operating within the inherent constraints of generative language models, such as LLMs. Conversations between humans and AI agents can potentially span weeks, months, and possibly years, containing hundreds or thousands of messages rich in context and valuable information. This presents a significant technical problem as AI agents, by design, only have a finite working memory—commonly referred to as a context window.

While context windows for state-of-the-art models have grown over time, they remain fundamentally limited, creating a technical challenge for maintaining coherent, contextually relevant conversations. This limitation forces systems to make critical decisions about which past information remains relevant and how to effectively retrieve and integrate it into responses. The problem is further complicated by the need to balance multiple competing technical factors: computational efficiency, cost considerations, response latency, and conversation quality.

Conventional approaches to managing conversation history often rely on simple recency-based methods, where only the most recent messages are retained within the context window. This approach is computationally straightforward but suffers from a critical technical flaw known as “catastrophic forgetting.” When the system only uses the most recent messages, it inevitably loses track of important long-term details such as major life events or past discussions that may be crucial for maintaining conversation coherence. This creates an experience where the AI appears to forget past conversations, significantly degrading the user experience and limiting the practical utility of conversational AI systems for extended interactions.

Another conventional approach attempts to address context limitations through generic summarization techniques, compressing past conversations to fit within context constraints. However, these techniques introduce their own set of technical challenges. Generic summarization often loses critical nuance, introduces bias or distortions, and frequently misprioritizes information—keeping less useful data while discarding crucial details. The technical challenge lies in determining how to intelligently compress and summarize past conversations while preserving the specific information that will be most relevant to future interactions, a task that generic summarization algorithms are poorly equipped to handle.

Another technical constraint in conversational AI systems is the fixed size of the context window, which is measured in tokens—the fundamental units that language models process. Tokens represent the smallest pieces of text that the model can understand, which may be words, parts of words, or even individual characters, depending on the specific tokenization scheme employed by the model. For example, in some models, the word “conversation” might be split into multiple tokens like “conver” and “sation,” while in others it might be a single token. The total number of tokens a model can process simultaneously is limited—ranging from a few thousand tokens in smaller models to tens of thousands in more advanced models. This token limit directly impacts the ability of the model to maintain conversation context, as each element in the context window (system instructions, user messages, AI responses, and tool outputs) consumes a portion of this finite token budget. Optimizing token usage becomes crucial for generating high-quality responses, as the model can only reason based on information present within its context window. When this window fills up, older information must be discarded or compressed, creating a fundamental tension between maintaining comprehensive context and operating within technical limitations.

Traditional systems typically employ static context window management, allocating fixed portions of the available token budget to different components of the conversation. This rigid approach fails to adapt to the dynamic nature of conversations, where the importance of different context elements varies significantly based on the conversation flow, topic shifts, and user needs. The technical challenge is that static allocation cannot efficiently utilize the limited context window, often wasting valuable tokens on less relevant information while excluding potentially critical context.

These conventional approaches leave several technical challenges unaddressed. First, there is the challenge of dynamically balancing the allocation of limited token resources across different types of conversational context (recent messages, historical summaries, and relevant past moments) in real-time as conversations evolve. Second, there is the challenge of maintaining conversation coherence across multiple communication channels with varying latency requirements and user expectations. For example, voice channels may prioritize low-latency responses by allocating fewer tokens to historical context retrieval, while text-based channels like SMS or email might allow for more comprehensive context inclusion. Third, there is the technical problem of efficiently retrieving and incorporating relevant historical context without introducing unacceptable latency or computational overhead, particularly in voice-based interactions where response time is critical.

Furthermore, as conversations extend over longer periods, the system must address the technical challenge of resolving potential contradictions or inconsistencies that emerge when preferences, interests, or beliefs of a user change over time. The system must also tackle the computational challenge of scaling these capabilities across numerous simultaneous users while maintaining performance and cost efficiency. These unresolved technical challenges highlight the need for a more sophisticated approach to message memory handling in conversational AI systems—one that can dynamically optimize context window usage while maintaining conversation quality across diverse communication channels and extended time periods.

An additional technical challenge arises when relevant information exists outside the direct conversation history. For instance, user profile information, preferences, or other contextual data may be stored in external systems but is crucial for providing personalized and relevant responses. In the case of an AI agent for an airline, a customer may update their profile with preferences such as seat type (aisle or window) or preferred airports outside of any specific conversation with the AI agent. Without a mechanism to incorporate this external information into the conversation context, the AI agent cannot provide optimal service—such as booking flights according to the known preferences of a customer—even though this information exists within the broader system. This creates a disconnect between available user data and the ability of the AI to leverage it during conversations.

Consistent with various embodiments of the present invention, a message memory handling system or memory service addresses the fundamental technical challenge of maintaining context over extended conversations in AI systems through a dynamic approach to context window management. This approach represents a significant advancement over conventional methods by implementing a multi-faceted solution that optimizes token usage while preserving conversation quality across diverse communication channels.

Consistent with some embodiments, the memory service utilizes a dynamic token budget allocation system that intelligently manages conversation history within the constraints of limited context windows. Unlike conventional approaches that rely on static allocation or simple recency-based methods, this innovative system dynamically determines the optimal distribution of tokens across different types of conversational context—recent verbatim messages, summarized older content, and relevant historical moments—based on the specific requirements of each interaction. This per-prompt dynamic adjustment ensures that each interaction with the language model is optimized for the current conversation state and available context window space.

The system begins by retrieving a full conversation history payload from a dedicated memory service. This payload includes all messages, summaries, and moments from the conversation history, regardless of length. Rather than attempting to fit this entire payload into the limited context window—which, in some instances, would be technically impossible for extended conversations—the system employs an algorithm to dynamically allocate a prompt budget based on the available context window. Importantly, this approach allows the system to maintain the complete conversation history in the memory service while only selecting the most relevant portions for inclusion in any given prompt.

This prompt budget determines precisely how many tokens should be allocated to recent verbatim messages, summarized content of older messages, and relevant older moments. The allocation is not fixed but adapts based on multiple factors including the communication channel, model specifications, available tools, and the current state of the conversation. For example, voice channels may prioritize low-latency responses by allocating fewer tokens to historical context retrieval (e.g., to moments), while text-based channels like SMS or email might allow for more comprehensive context inclusion. In other words, during a voice channel conversation, the AI agent may allocate fewer tokens to moments and more tokens to messages and/or summaries in comparison to conversations conducted via text-based channels. In addition, or alternatively, during a conversation via a text-based channel, the AI agent may allocate more tokens to moments and fewer tokens to messages and/or summaries in comparison to when the conversation is conducted via a voice channel. Moreover, real-time messaging applications such as WhatsApp or chat interfaces would receive different token allocations than asynchronous communication methods like customer support tickets or forum discussions.

With some embodiments, one technical innovation is the ability of the memory service to assemble a prompt for the generative language model by strategically selecting conversation history elements to fit within the allocated prompt budget. This selection process balances between recent verbatim messages (providing immediate context), summarized content of older messages (maintaining conversation continuity), and relevant older moments (preserving important historical context). This balanced approach ensures that the most pertinent information is always available to the language model, regardless of how long the conversation has been ongoing.

Furthermore, consistent with some embodiments, the system implements an iterative adjustment mechanism that continuously recalculates the prompt budget and reassembles the prompt as new information is added from language model outputs or tool calls. This dynamic adjustment ensures that the context window is always optimally utilized, even as the conversation evolves and new data is introduced. Tools, in this context, refer to external resources or functions that the AI agent can access to retrieve information or perform actions outside its immediate knowledge, such as APIs, database queries, or other specialized services. A tool call occurs when the AI agent determines it needs additional information and invokes one of these external resources to fulfill a user request. For example, when a tool call returns a large JSON response that consumes a significant portion of the available token budget, the system automatically recalculates how many verbatim messages and how much summarization can fit in the remaining space, ensuring optimal use of the limited context window.

Consistent with some embodiments, the memory management system incorporates an advanced approach to identifying and retrieving relevant historical moments from past conversations. Unlike conventional systems that might rely on simple keyword matching or chronological retrieval, this system employs vector retrieval and advanced search algorithms to identify truly relevant historical context. The system can utilize both semantic search with vector databases and lexical search methods, combining these approaches to identify the most relevant historical information. This ensures that when a user references a conversation from weeks or months ago, the system can efficiently locate and incorporate that context into the current interaction.

Another technical advancement is the channel-aware processing of the system, which optimizes memory handling based on the specific requirements of different communication channels. For voice interactions, where latency is critical, the system may prioritize immediate response generation over extensive historical context retrieval. For text-based channels with more relaxed latency requirements, the system can perform more comprehensive context analysis and retrieval. The conversation router component determines how to handle incoming messages based on the communication channel, routing some messages for immediate processing and others for asynchronous summarization, allowing for efficient resource utilization while maintaining conversation quality across all channels.

Consistent with some embodiments, the memory management system also addresses the challenge of summarization through specialized generative language models specifically trained for this task. Rather than relying on generic summarization techniques that often lose critical nuance, the system employs models optimized for conversational summarization, ensuring that the most relevant information is preserved while less important details are condensed or omitted. The conversation consumer component processes messages asynchronously, generating summaries and vector embeddings that enable efficient retrieval of relevant historical context in future interactions. This specialized approach to summarization significantly improves the quality of context preservation compared to conventional methods.

Additionally, the system incorporates a trait system that stores and retrieves user-specific information across multiple interactions and channels. This allows for personalization of responses based on user preferences, interests, and past interactions, addressing the challenge of maintaining consistent user context over extended periods. The trait system works bidirectionally—extracting traits from conversations and inferring which traits are relevant to the current conversation context. For example, if a user mentions they “love blue shoes,” the system can extract this preference and store it as a trait. Later, when the conversation turns to footwear, the system can incorporate this previously identified preference into the prompt, enabling more personalized responses without requiring the user to restate their preferences.

Additionally, the system can directly query external data services to incorporate information about users that was generated or collected outside the context of the AI-facilitated conversation. This capability allows the system to access and integrate relevant user data from various sources such as customer relationship management systems, user profiles, or other enterprise databases without requiring this information to be explicitly mentioned in the conversation history. For example, in a customer service scenario for an airline, when a customer engages with the AI agent about booking a flight, the system can query the customer database of the airline to retrieve the customer information, including frequent flyer status, accumulated miles, previously reported seating preferences (aisle or window), and preferred departure airports—all information that was provided or collected through other channels such as the airline's website, mobile app, or previous in-person interactions. The system can then incorporate this external information into the prompt construction process, enabling the AI agent to offer personalized flight recommendations that align with the customer's known preferences (e.g., “I see you typically prefer window seats on morning flights from SFO—I've found several options that match these preferences”) without requiring the customer to explicitly state these preferences within the current conversation. This seamless integration of external user data significantly enhances the personalization capabilities of the system while maintaining natural conversation flow.

From an implementation perspective, with some embodiments, the system employs a distributed architecture with dedicated components for different aspects of memory management. An AI agent serves as the central processing unit, interacting with the generative language model and coordinating the memory management process. A conversation router determines how to handle incoming messages based on the communication channel, while a memory service stores and retrieves conversation history. This modular architecture ensures scalability and reliability, addressing the computational challenges associated with managing extended conversations for numerous users simultaneously.

The technical advantages of this approach are substantial. By dynamically optimizing context window usage, the system significantly reduces computational costs compared to approaches that attempt to process the entire conversation history. The selective inclusion of relevant historical context ensures that the AI agent maintains conversation coherence over extended periods, addressing the “catastrophic forgetting” problem that plagues conventional systems. The channel-specific optimization ensures consistent performance across diverse communication methods, from voice to text to email, each with their own unique requirements and constraints.

Moreover, the ability of the system to maintain the full conversation history in the memory service while selectively including relevant portions in the context window represents a fundamental advancement over conventional approaches. This allows the system to maintain conversation context indefinitely, regardless of the length of the interaction, while still operating within the technical constraints of limited context windows.

In practical terms, embodiments described herein enable AI systems to maintain coherent, contextually relevant conversations over extended periods—weeks, months, or even longer—without sacrificing response quality or computational efficiency. Users can reference past conversations, and the system can intelligently retrieve and incorporate that context, creating a more natural and engaging interaction experience. This addresses a critical limitation of conventional conversational AI systems and opens up new possibilities for long-term AI-human interactions across diverse domains and use cases. The disclosed allocation and use of the prompt budget may result in an improved man-machine interaction, particularly because the AI agents may be able to more realistically imitate a competent human agent.

The trait system provides a particularly powerful solution for incorporating information that exists outside the direct conversation context. By abstracting the trait system from any specific implementation (such as a customer relationship management system or user profile database), the system can flexibly integrate with various external data sources. For example, in an airline customer service scenario, when a customer updates their seat preference (aisle or window) or preferred airports in their profile outside of any conversation with the AI agent, this information can be retrieved by the trait system and incorporated into the conversation context when relevant. This allows the AI agent to provide personalized service—such as booking flights according to known preferences—without requiring the customer to explicitly state these preferences in each conversation. The trait system thus bridges the gap between external user data and the conversation context of the AI model, enabling more intelligent and personalized interactions.

Furthermore, the system can incorporate cost considerations when determining the optimal allocation of tokens within the context window. Different language models have varying capabilities, token limits, and associated costs. By considering these factors during the dynamic budget allocation process, the system can optimize not only for conversation quality but also for computational efficiency and cost-effectiveness. For more complex queries that require advanced reasoning capabilities, the system might allocate more tokens to ensure the language model has sufficient context, even if this incurs higher costs. For simpler queries, the system might use a more streamlined context representation, reducing computational overhead while maintaining response quality. This cost-aware approach ensures that organizations can deploy conversational AI systems at scale while maintaining control over computational expenses, representing another significant advancement over conventional approaches that do not consider the economic implications of context window management.

### Context Window Structure

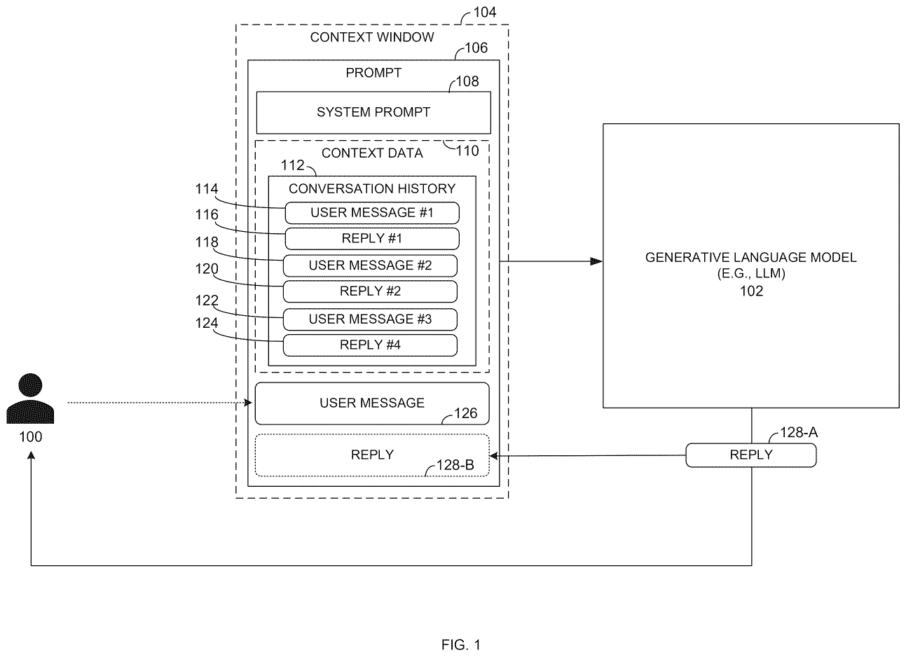

FIG. 1 illustrates a conversational AI system that depicts the fundamental structure and operation of a context window 104 in a generative language model environment. The figure shows the interaction between a user 100 and a generative language model 102 (e.g., an LLM), mediated through a context window 104 that, in this example, contains various data components essential for maintaining conversation coherence. The context window 104 represents the finite memory capacity of the language model, which contains all information available to the model when generating a response. Within this context window, a prompt 106 is structured to include a system prompt 108 and context data 110. The system prompt 108 typically contains instructions that guide the behavior of the model and its response style, while remaining fixed throughout the conversation.

### System Prompt and Context Window Data

For example, a system prompt 108 might contain instructions such as: “You are a helpful, knowledgeable AI agent. Respond to user queries in a friendly and informative manner. Provide accurate information and when you are uncertain, acknowledge the limitations of your knowledge. Maintain a professional tone while being conversational. Do not use offensive language or provide harmful information. If asked to perform tasks beyond your capabilities, politely explain your limitations. Always prioritize user safety and privacy in your responses.” This type of system prompt establishes the persona, behavioral boundaries, and response characteristics of the AI model, which then remain consistent throughout the conversation, providing a foundation for all interactions while the conversation history and user inputs may change.

### Conversation History Management

The context data 110 includes conversation history 112, which maintains a record of previous exchanges between the user 100 and the AI system. This conversation history comprises a series of user messages and corresponding replies, specifically showing user message #1 116, reply #1 118, user message #2 120, reply #2 122, and user message #3 124. The most recent user message 126 is also included in the context window, with a placeholder for the forthcoming reply 128-B that will be generated by the language model 102 and returned to the user as reply 128-A.

### Limitations of Static Context Windows

As the conversation progresses, the context window 104 becomes populated with an increasing number of messages. In a conventional implementation, each new message pair (user message and AI reply) is simply appended to the conversation history. This approach works well for short conversations but presents significant technical challenges as conversations extend over longer periods. The context window 104 has a finite capacity (typically measured in tokens), which means it cannot indefinitely accumulate conversation history. As new messages are added, older messages may need to be removed or compressed, potentially causing the AI to “forget” important earlier context.

In the conventional approach, the entire conversation history occupies a significant portion of the available token budget, potentially wasting tokens on irrelevant or redundant information while leaving insufficient space for new information or complex reasoning. The system as illustrated in FIG. 1 would prioritize recent messages (those that fit within the context window), potentially leading to “catastrophic forgetting” where important information from earlier in the conversation is lost simply because it occurred too far back in the conversation history. The illustration shows a static approach to context window management, where the system does not dynamically adjust how much space is allocated to different components based on their relevance or importance to the current exchange.

The memory service described herein directly addresses the limitations illustrated in FIG. 1 through several innovative approaches. In contrast to the static context window management shown in FIG. 1, the memory service dynamically allocates tokens within the context window 104 based on the specific requirements of each interaction, balancing between system prompt, recent verbatim messages, summarized content, and relevant historical moments, and in some instances, data obtained from external sources such as trait services, API calls, or database queries. Moving beyond the simple chronological conversation history 112 depicted in the figure, the memory service implements an intelligent approach that combines recent verbatim messages with summarized older content and selectively retrieved relevant historical moments or “memories” from past conversations.

To overcome the context window 104 limitations shown in FIG. 1, the memory service maintains the complete conversation history in a dedicated storage system, allowing it to retrieve and incorporate relevant historical context as needed, even if that context originated far earlier in the conversation. Unlike the limited approach illustrated in FIG. 1, the memory service stores both raw verbatim messages and summarized content, enabling the AI agent to make optimal decisions about which elements to include in each prompt based on the available token space.

Solving the static allocation problem depicted in FIG. 1, the memory service continuously recalculates the prompt budget and reassembles the prompt as new information is added from language model outputs or tool calls (where tools refer to external resources or functions that the AI agent can access, such as APIs or database queries). This dynamic adjustment ensures optimal utilization of the context window throughout the conversation. For example, when a tool call returns a large response that consumes a significant portion of the available token budget, the memory service automatically recalculates how many verbatim messages and how much summarization can fit in the remaining space, addressing the inefficient token usage illustrated in FIG. 1.

To further improve upon the static approach shown in FIG. 1, the memory service optimizes memory handling based on the specific requirements of different communication channels, with a conversation router determining how to handle incoming messages. For voice interactions, where latency is critical, the memory service may prioritize immediate response generation over extensive historical context retrieval. For text-based channels with more relaxed latency requirements, the memory service can perform more comprehensive context analysis. Through these innovations, the memory service transforms the static context window illustrated in FIG. 1 into a dynamic, adaptive system capable of maintaining conversation coherence over extended periods while optimizing for both performance and cost efficiency.

### High-Level Architecture Overview

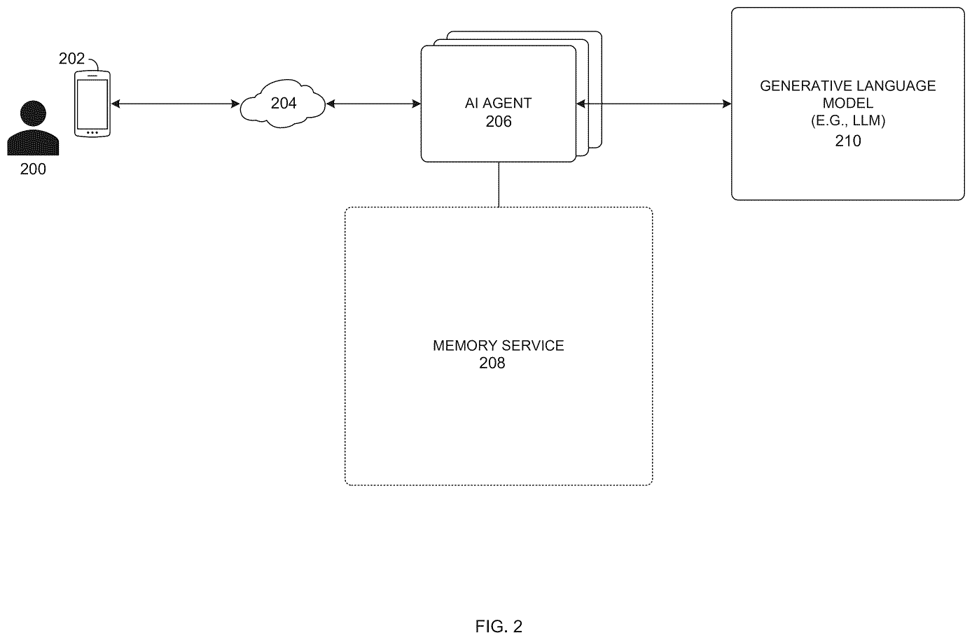

FIG. 2 illustrates a high-level architecture 200 of a conversational AI system that implements dynamic context window management capabilities. The figure depicts the key components and their interactions within the system, providing a foundation for understanding the more detailed implementation shown in subsequent figures.

### User and Device Interaction

At the left side of the diagram, a user 200 interacts with the system through a user device 202, which could be a mobile phone, computer, or other communication device. The user device 202 connects to the system through a network connection 204, which facilitates the transmission of messages between the user and the AI system.

### AI Agent Framework

The architecture shows multiple AI agents, including AI agent 206, which serve as the core processing units for managing conversations with users. Each AI agent can independently interact with users while leveraging the shared memory service. This design enables scalability and flexibility, allowing multiple AI agents to benefit from the same memory management capabilities as part of a comprehensive cloud-based communications platform.

### Memory Service Integration

Connected to the AI agent 206 is the memory service 208, which represents a key innovation in the system. The memory service 208 is offered as part of a broader cloud-based communications platform that enables developers to create, deploy, and manage AI agents through software development kits (SDKs) and application programming interfaces (APIs). This platform integrates with a comprehensive suite of services including a customer data platform, programmable voice and messaging services, and other communication tools. The memory service stores and manages the complete conversation history, including raw messages, summarized content, and relevant historical moments, while providing developers with simplified interfaces that abstract away the complexity of memory management. This centralized approach allows developers to focus on creating specialized AI agents for their specific use cases while leveraging the memory management capabilities of the platform, enabling their AI agents to maintain indefinitely long conversations while optimizing the use of limited context windows for each specific interaction.

The memory service 208 facilitates easy development of AI agents by abstracting away the complexity of memory management. By providing a unified interface for storing and retrieving conversation data, the memory service enables developers to create AI agents without having to implement their own memory management solutions. This shared service approach allows multiple AI agents to benefit from memory handling capabilities without duplicating functionality.

### Generative Language Model (e.g., LLM) Integration

On the right side of the diagram is the generative language model 210 (e.g., an LLM), which processes the dynamically generated prompts and produces responses. The bidirectional arrow between the AI agents and the language model indicates the iterative nature of their interaction, with prompts being sent to the model and responses being returned for processing and delivery to the user. As part of the comprehensive cloud-based communications platform, the system is designed with model flexibility in mind, allowing customers to integrate and utilize various language models based on their specific needs. Developers can direct traffic to their preferred LLMs through easy configuration options, including their own proprietary models, models provided by the platform itself, or third-party models from various providers. The platform includes a user-friendly interface that enables developers to quickly select and configure appropriate models for their AI agents, specifying parameters and connection details. This model-agnostic approach ensures that customers can leverage the most suitable language models for their specific use cases, whether optimizing for cost, performance, or specialized capabilities, while still benefiting from the memory management capabilities of the platform.

### Cloud-Based Platform Capabilities

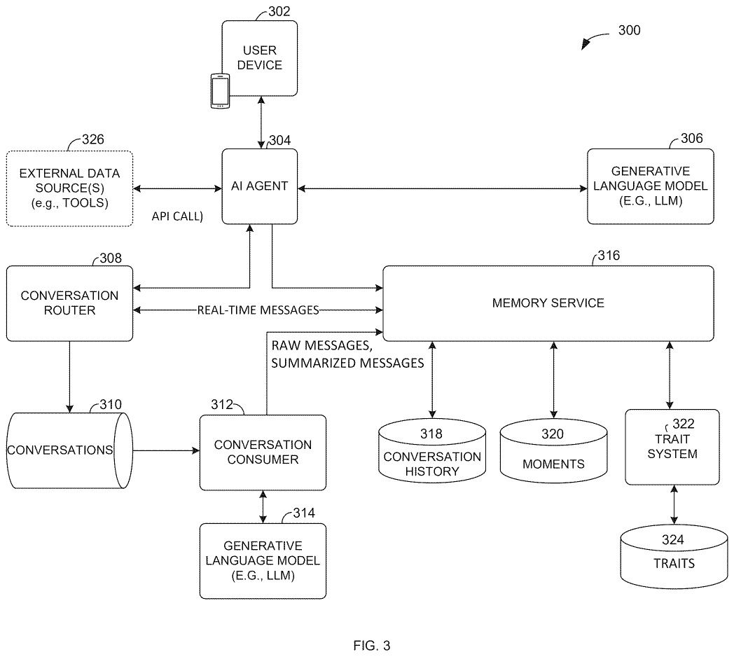

This architecture addresses the fundamental challenge of context window limitations by separating the complete conversation storage (handled by the memory service 208) from the AI agents 206 that construct prompts for the language model 210. This separation allows the system to maintain indefinitely long conversations while optimizing the use of the limited context window for each specific interaction. The memory service 208 ensures that this process remains coherent and contextually appropriate across the entire conversation lifecycle. The high-level view presented in FIG. 2 establishes the foundational components that will be explored in more detail in FIG. 3, which expands on this architecture to show the specific mechanisms for memory management, conversation routing, and trait handling within the broader system.

### Memory Management Architecture

FIG. 3 illustrates a comprehensive memory management architecture 300 for conversational AI systems that expands upon the high-level architecture shown in FIG. 2. At the core of this architecture is the interaction between the user device 302, AI agent 304, generative language model 306, and external data sources 326. When a user sends a user message through the user device 302, the AI agent 304 receives this user message and is responsible for generating an appropriate response. This process may, in some instance, involve a single interaction with the generative language model 306, but may also involve multiple rounds of interaction between the AI agent 304 and the generative language model 306, as well as potential calls to external data sources 326 via API calls, before a final response is delivered to the user, via user device 302.

### AI Agent and User Interaction

In some instances, the AI agent 304 generates responses to user messages through a multi-step process. When a user message is received, the AI agent 304 first determines which communication channel it came from and then requests the full conversation history from the memory service 316. Based on this information, the AI agent 304 dynamically allocates a prompt budget, determining precisely how many tokens to allocate for recent verbatim messages, summarized content, and relevant historical moments. This per-prompt dynamic adjustment ensures that each interaction with the language model is optimized for the current conversation state and available context window space.

Upon receiving a user message, the AI agent 304 makes a single, comprehensive call to the memory service 316, which returns a unified payload containing all relevant conversation data. This payload includes the complete conversation history from the conversation history database 318, relevant moments from the moments database 320, and applicable user traits from the trait system 322. Here, a “moment” refers to a specific portion of a past conversation that has been identified as particularly relevant to the current context—these are stored, in some instances, as vector representations within the moments database 320, facilitating semantic retrieval through similarity-based searches rather than relying solely on simple chronological access. Alternatively, lexical search may be employed independently or in conjunction with semantic retrieval, wherein results from both methods are combined and weighted to enhance relevance and accuracy. It should be noted that in implementations where both search types are utilized with results being combined and weighted, such functionality would necessarily require one or more additional databases not explicitly shown in FIG. 3 to support the different search methodologies and their integration. The payload may also include user-specific traits, which are personalized attributes or preferences that have been extracted from previous conversations, such as product preferences or demographic information, or otherwise generated and stored by the trait system 322. These traits are obtained from the trait system 322 shown in FIG. 3, which serves as a dedicated service for managing user traits. Importantly, these traits may be related to current or past conversations conducted through the AI agent system but may also include data that has been derived outside the context of the AI agent system, such as through a customer data platform, user profiles, external databases, or other means by which a particular user would provide information. The trait system 322 is designed to collect, store, and retrieve this diverse trait information, making it available to enhance the contextual relevance of AI-generated responses. While FIG. 3 illustrates the primary components of the memory management architecture, it should be understood that in various implementations, additional databases beyond those explicitly shown may be present to support different search methodologies and data storage requirements.

Once this comprehensive payload is received, the AI agent 304 independently analyzes its contents and based on the calculated prompt budget, channel characteristics, and conversation requirements, determines which elements to include in the prompt. The AI agent 304 strategically allocates tokens between recent verbatim messages, summarized older content, relevant historical moments, and trait information, constructing an optimized prompt that fits within the available context window while preserving the most contextually important information. This dynamic prompt construction process ensures that the generative language model 306 receives the most relevant information for generating an appropriate response, even when the full conversation history exceeds the context window limitations.

In many cases, the AI agent 304 may need to engage in multiple interactions with the generative language model 306 and external data sources 326 before generating a final response to the user. For example, after constructing an initial prompt and sending it to the generative language model 306, the model may indicate that it lacks sufficient information to provide an accurate response. In such cases, the AI agent 304 makes an API call to an appropriate external data source 326 to retrieve the necessary information. Once the external data is received, the AI agent 304 recalculates the token budget to accommodate this new information, constructs a new prompt that incorporates the external data, and sends this updated prompt to the generative language model 306. Only after receiving a satisfactory response from the model does the AI agent 304 formulate and send the final reply to the user device 302.

For example, consider a scenario where a frequent business traveler has been using an AI agent of an airline for several years to manage their travel arrangements. The traveler sends a message: “I need to change my upcoming flight to Chicago and book a hotel near our downtown office.” The AI agent 304 would first construct a prompt incorporating the user's message and relevant conversation history, then send this to the generative language model 306. The model might respond that it needs specific information about the traveler's current booking and the company's office location to provide accurate assistance.

The AI agent 304 would then make multiple API calls to external data sources 326: first to the airline's reservation system to retrieve the traveler's current booking details (which might consume 1,500 tokens), then to the company's corporate travel database to identify the downtown office location and preferred hotel partners (consuming another 1,200 tokens). The AI agent would also query the traveler's historical preferences stored in the trait system 322, retrieving information about their preferred seating, hotel amenities, and typical travel patterns (consuming 800 tokens).

After receiving all this data, the AI agent 304 would recalculate the token budget to accommodate this wealth of information. With the context window now significantly filled with external data, the AI agent would need to make strategic decisions about which conversation history elements to include. It might retain only the most recent 5-10 messages verbatim (perhaps related to this specific trip planning), include a summarized version of conversations from the traveler's previous Chicago trips (pulled from the moments database 320), and incorporate key traits about the traveler's preferences.

This updated prompt, carefully balanced to fit within the available context window while preserving the most relevant information, would be sent to the generative language model 306. The model would then generate a comprehensive response that incorporates the current booking details, available flight options, hotel recommendations based on proximity to the office and the traveler's historical preferences, and even suggestions based on the traveler's past behavior patterns in Chicago. Finally, the AI agent 304 would deliver this personalized response to the user device 302, providing a seamless experience that leverages years of conversation history and external data while optimizing the limited context window.

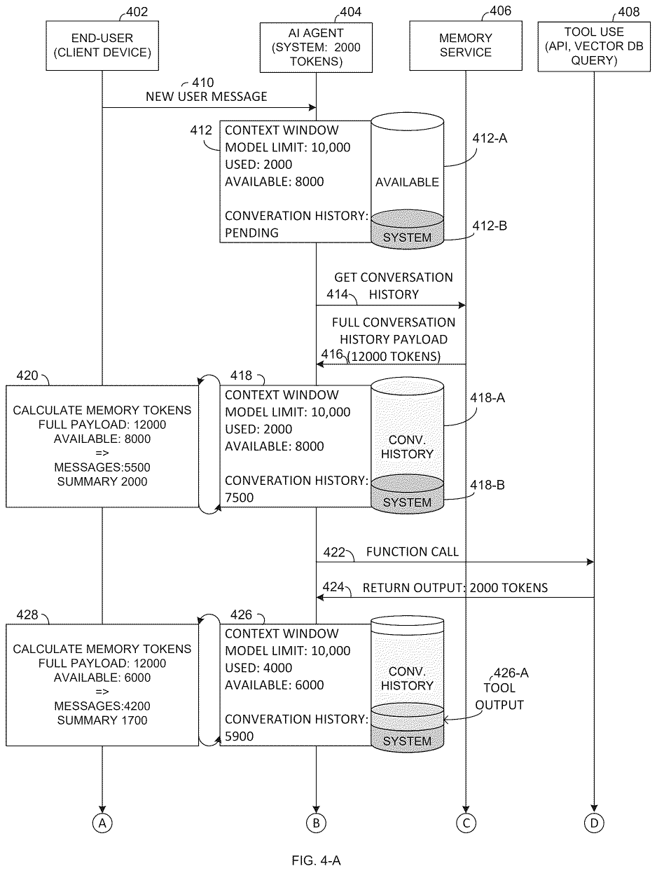

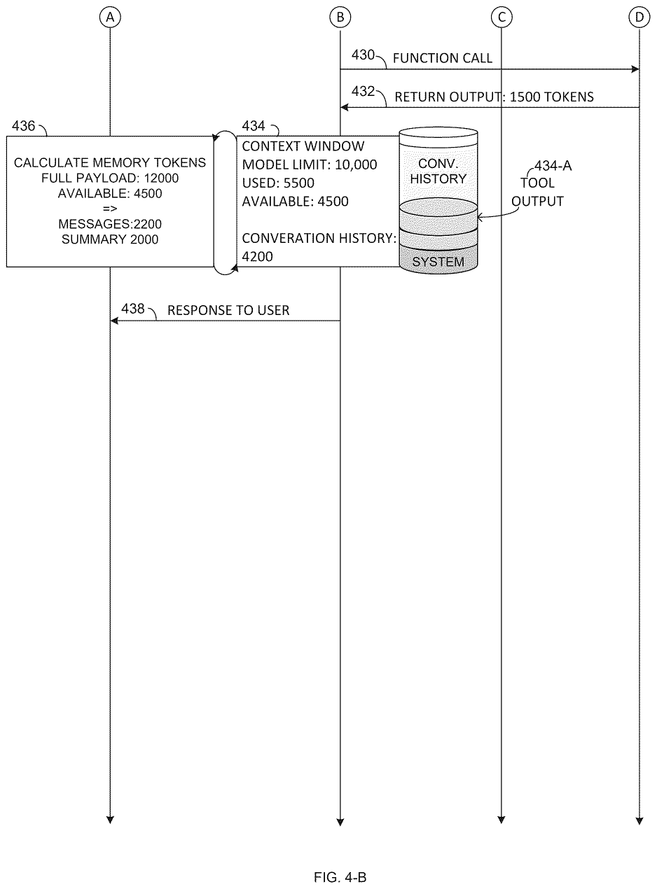

The token budget calculation process involves balancing multiple competing factors. For each prompt sent to the language model 306, the AI agent 304 must determine how to distribute the available tokens between recent verbatim messages (which provide immediate context), summarized older content (which maintains conversation continuity), relevant historical moments (which preserve important long-term context), and any data retrieved from external sources. This calculation takes into account the communication channel characteristics, the complexity of the current conversation, and the specific requirements of the interaction. As shown in FIGS. 4-A and 4-B, the AI agent continuously recalculates this token budget as new information is added, such as when tool responses consume portions of the available context window.

Developers can configure and customize the AI agent 304 through a comprehensive set of APIs and configuration options provided by the cloud-based communications platform. The platform offers a development user interface that allows developers to specify which external data sources or tools their AI agent can access. Through this interface, developers can select from pre-built integrations with common services (such as weather APIs, knowledge bases, or customer databases), configure authentication credentials for these services, and define the specific endpoints or functions that their AI agent is permitted to call. The interface also allows developers to create custom tool definitions by specifying the API endpoint, required parameters, authentication method, and expected response format.

With some embodiments, the development interface provides a visual tool configuration panel where developers can test their tool integrations in real-time, viewing the exact requests being sent and responses being received. This allows for rapid iteration and debugging of tool configurations. Additionally, developers can set up policies that govern how and when tools are used, such as rate limiting to prevent excessive API calls, fallback strategies for when external services are unavailable, and prioritization rules that determine which tools should be tried first when multiple options are available. These configurations are stored as part of the AI agent's definition and are automatically applied whenever the agent processes a user message that might require external data.

### External Data Sources Integration

Consistent with some embodiments, the communications platform provider, the provider of the configuration AI agent service, may also provide developers with the flexibility to select and configure which generative language models to use for different aspects of the system. Developers can choose from models provided by the platform itself, integrate their own proprietary models, or connect to third-party model providers through a simple configuration interface. This model-agnostic approach allows developers to optimize for different requirements, such as using more powerful models for complex reasoning tasks and more efficient models for summarization or other specialized functions. The platform handles the integration details, ensuring that the AI agent 304 can seamlessly communicate with the selected models while maintaining optimal context window management.

### Conversation Router

The conversation router 308 represents a key innovation in this architecture, serving as an intelligent traffic management system that determines how to process incoming messages based on their communication channel characteristics. The conversation router 308 analyzes each incoming message and makes decisions about message handling based on channel-specific requirements and constraints. For voice channels, where response latency is critical to maintaining natural conversation flow, the conversation router 308 prioritizes immediate processing by sending messages directly to the memory service 316 as “REAL-TIME MESSAGES.” This direct routing ensures that voice interactions with the AI agent 304 maintain the low-latency requirements necessary for natural conversation. For text-based channels with more relaxed latency requirements, such as SMS, email, or messaging applications, the conversation router 308 can allocate resources for more comprehensive context analysis and processing.

The conversation router 308 implements decision-making logic based on the underlying technical characteristics of different communication channels. Voice channels typically maintain persistent connections over web sockets with streaming text, keeping users connected to the same Kubernetes pod on the same physical host throughout the conversation. This persistent connection architecture allows the system to leverage in-memory caching of conversation data, significantly reducing retrieval times for context information. In contrast, text-based channels often use discrete POST requests that may be distributed across multiple servers, requiring different handling approaches. The conversation router 308 accounts for these architectural differences when determining the optimal routing path for each message.

When processing messages, the conversation router 308 maintains bidirectional connections with both the AI agent 304 and the memory service 316, as shown in FIG. 3. This dual connectivity allows it to receive routing instructions from the AI agent 304 while also directly forwarding messages to the memory service 316 when immediate processing is required. The conversation router 308 also connects to the conversations queue 310, which serves as a temporary storage mechanism for asynchronous processing of messages that do not require real-time handling. This architecture enables the system to efficiently manage message flow between the user device 302, AI agent 304, and memory service 316, while optimizing for different channel requirements.

The conversation router 308 also implements channel-specific optimization strategies that integrate with the moments database 320 and trait system 322 shown in FIG. 3. For example, when handling voice interactions, the conversation router 308 may disable extensive searches for historical moments in the moments database 320 to maintain response speed, while enabling these searches for text-based channels where users expect more comprehensive responses. Similarly, the conversation router 308 may adjust how trait information from the trait system 322 is incorporated into conversations based on channel characteristics. This channel-aware approach extends beyond simple latency considerations to include other channel-specific characteristics such as message size limitations, formatting requirements, and user expectations for response complexity. By intelligently routing messages based on these factors, the conversation router 308 ensures that each communication channel receives optimized handling tailored to its specific technical requirements and user experience expectations.

With some embodiments, the conversation router 308 facilitates efficient message handling by informing the AI agent 304 about channel-specific requirements and constraints. Based on this information, the AI agent 304 makes appropriate decisions about API calls to external data sources 326 (e.g., tools), prioritizing quick-returning calls for voice channels and allowing more complex operations for text-based channels. This architecture maintains channel-aware optimization while preserving clear separation of responsibilities between system components.

### Conversations Queue and Consumer

The conversations queue 310 serves as a message queuing system that temporarily stores messages for asynchronous processing. Unlike simple storage systems, the conversations queue 310 is specifically designed to handle high message volumes efficiently while maintaining conversation coherence across multiple communication channels. This cylindrical component depicted in FIG. 3 implements a first-in-first-out (FIFO) queue architecture that enables the system to batch process messages, optimizing resource utilization particularly during periods of high traffic. The conversations queue 310 acts as a buffer between the conversation router 308 and the conversation consumer 312, allowing the system to manage bursts of incoming messages without overwhelming downstream components or introducing unacceptable latency.

The conversation consumer 312 functions as an intelligent processing engine that systematically retrieves and processes messages from the conversations queue 310. This component performs several functions that transform raw conversation data into optimized formats for efficient storage and retrieval. The conversation consumer 312 pulls batches of messages from the queue 310 and analyzes them to identify key information, patterns, and context. It then performs two primary operations: summarization and data indexing. For summarization, the conversation consumer 312 utilizes a dedicated generative language model 314 that is specifically optimized for conversational summarization tasks. This specialized model enables efficient compression of conversation history while preserving key semantic information, addressing the fundamental challenge of maintaining context within limited token budgets.

With some embodiments, the conversation consumer 312 functions as an intelligent processing engine that systematically processes messages from the conversations queue 310 for storage in databases, accessible in some instances via lexical search, semantic search or both. For instance, when processing these messages, the conversation consumer 312, in some examples, transforms raw conversation data into vector embeddings—high-dimensional numerical representations that capture semantic meaning. These vector embeddings enable efficient similarity searches through semantic retrieval mechanisms, allowing the system to identify contextually relevant information based on meaning rather than exact keyword matches. The conversation consumer 312 utilizes a dedicated generative language model 314 to analyze conversation content and generate these vector representations, which are then stored in the memory service 316 for later retrieval by the AI agent 304.

In some embodiments, the generative language model 314 is specifically configured to perform specialized tasks related to conversation analysis and processing. One technique used to configure the model for these tasks is instruction tuning, where the model is fine-tuned with explicit instructions and examples of how to analyze conversations, identify key information, and generate effective summaries. This approach involves providing the model with carefully crafted prompts that guide it to focus on extracting relevant details from conversations, identifying potential moments of significance, and condensing lengthy exchanges into concise summaries while preserving semantic meaning. The instruction tuning process typically involves training the model on thousands of conversation-summary pairs with explicit instructions about what constitutes a good summary versus a poor one.

Another technique employed is domain-specific fine-tuning, where the generative language model 314 is further trained on datasets consisting specifically of conversational data relevant to the types of interactions the system will handle. This approach modifies the model's parameters to optimize its performance for conversation summarization tasks by exposing it to diverse examples of conversations and their ideal summaries across various contexts and communication channels. Additionally, some implementations utilize parameter-efficient fine-tuning methods such as Low-Rank Adaptation (LoRA) or prompt tuning, which allow for specialized model behavior without modifying all model parameters. These techniques enable the model to maintain its general language capabilities while developing specialized skills for identifying conversation moments, extracting user traits, and generating concise yet comprehensive summaries that capture the essential elements of conversations while significantly reducing token usage.

In some embodiments, the conversation consumer 312 may process messages for storage in traditional index databases, in addition to, or instead of, vector databases. In these implementations, the conversation consumer 312 creates keyword-based indices that enable conventional lexical search functionality. This approach involves extracting key terms, phrases, and concepts from conversations and organizing them into searchable indices according to predefined domain-specific ontologies or taxonomies. These ontological frameworks may be structured hierarchically to categorize conversation content based on industry-specific terminology, user intent patterns, or semantic relationships between concepts. For example, a travel industry ontology might organize concepts into hierarchical categories such as transportation, accommodations, and activities, with further subcategories and relationships defined between them. The system may also generate and store extensive metadata associated with each message, including timestamps, conversation session identifiers, channel types (voice, SMS, email), participant information, and interaction sequence markers. This rich metadata enables sophisticated temporal and contextual queries, allowing messages to be retrieved chronologically, by date range, by conversation topic evolution, or by interaction patterns. The lexical indices, combined with this structured metadata, allow for precise keyword matching and contextual filtering, enabling the system to quickly retrieve conversation segments containing specific terms or occurring within particular timeframes, even when the broader semantic context might vary across different conversations.

In yet other embodiments, the conversation consumer 312 may be implemented to use a hybrid approach where conversation summaries, referred to herein as conversation moments, or simply moments, are made accessible through both vector databases and traditional keyword indices simultaneously. This dual-storage strategy combines the strengths of both approaches—vector databases excel at finding semantically similar content even when keywords don't match, while lexical search excels at precise term matching. This hybrid approach combines the strengths of both storage methodologies—vector databases excel at finding semantically similar content even when keywords don't match, while lexical search excels at precise term matching. The system leverages both vector databases and traditional keyword indices simultaneously, enabling more comprehensive information retrieval capabilities. This complementary approach allows the system to merge results from both search methods, providing more accurate and relevant responses as some queries may be better served by semantic similarity while others benefit from exact keyword matching.

In implementing this hybrid approach, the system employs sophisticated weighting and combination algorithms to identify the most relevant material from both search methodologies. When a query is processed, the system simultaneously executes both semantic vector-based searches and lexical keyword-based searches against their respective databases. Each search method generates its own relevance scores for potential matches—vector searches calculating similarity distances between embeddings, while lexical searches determining keyword match quality using algorithms such as BM25. The system then applies configurable weighting factors to each result set based on the query characteristics and conversation context. For example, queries seeking conceptual understanding might assign higher weights to vector search results, while queries containing specific terminology might prioritize lexical matches. The combined results undergo a fusion process where overlapping matches receive boosted relevance scores, recognizing that content identified by both methodologies likely has higher relevance. Additionally, the system implements contextual re-ranking that considers factors such as recency, conversation topic continuity, and user interaction patterns to further refine result relevance. This dynamic weighting approach adapts to different query types and conversation contexts, ensuring that the most appropriate search methodology dominates for each specific information need while still benefiting from the complementary strengths of both approaches.

The specific database implementations may vary depending on deployment scenarios. In some embodiments, the service provider offers default database configurations that are pre-optimized for general use cases. However, in some instances, the system also supports extensive customization options for developers creating AI agents using the platform's tools. Through the development interface, developers can select, activate, and enhance specific database services for use with their AI agents. They may choose to utilize vector databases for semantic search capabilities, traditional search index databases for precise keyword matching, or both simultaneously depending on their specific requirements. This flexibility allows developers to tailor the memory and retrieval mechanisms to their particular use cases, optimizing for factors such as response accuracy, retrieval speed, or storage efficiency.

After processing, the conversation consumer 312 sends both the raw verbatim messages and their summarized versions to the memory service 316 for storage in the conversation history database 318 and the moments database 320. The moments database 320 can be implemented as either a vector database for semantic retrieval or a traditional database with lexical indexing, or one for each flavor. This flexibility allows the system to leverage the strengths of both approaches—vector databases excel at finding semantically similar content even when keywords do not match, while lexical search engines like Elasticsearch or OpenSearch using algorithms such as BM25 excel at precise keyword matching. The memory service 316 may also integrate with additional databases not explicitly shown in FIG. 3, allowing for specialized storage and retrieval mechanisms tailored to different search requirements.

With some embodiments, the conversation consumer 312 implements batching algorithms that optimize processing efficiency. Rather than processing each message individually, it aggregates multiple messages into processing batches, allowing for more efficient use of computational resources, particularly when interacting with the generative language model 314. This batching approach is especially valuable during high-volume periods, as it reduces the number of separate calls to the language model while maintaining processing throughput. The architecture of the conversation consumer is designed to scale horizontally, allowing multiple instances to process different batches simultaneously when needed to handle increased load.

Consistent with some embodiments, the conversation router 308 may be implemented with a distributed messaging service architecture to efficiently manage message flow throughout the system. Accordingly, in some instances, the conversation router 308 functions as a publisher that publishes messages to the conversations queue 310, while the conversation consumer 312 operates as a subscriber that retrieves and processes these messages in batches. This publish-subscribe pattern may be implemented using distributed messaging platforms such as APACHE KAFKA®, RABBITMQ®, or AMAZON KINESIS®. for Example, when the conversation router 308 receives messages from different communication channels, it publishes these messages to appropriate topics in the messaging service based on channel characteristics and processing requirements.

For example, when the conversation router 308 receives messages from different communication channels, it publishes these messages to appropriate topics in the messaging service based on channel characteristics and processing requirements. The conversation consumer 312 then subscribes to these topics and pulls batches of messages from the conversations queue 310 for efficient processing, allowing for horizontal scaling where multiple consumer instances can process different message batches simultaneously during high-volume periods. This architecture enables the system to handle bursts of incoming messages without overwhelming downstream components, while maintaining the ability to process messages asynchronously based on their priority and channel requirements.

### Memory Service

With some embodiments, the memory service 316 serves as the central orchestration layer for conversation data management within the system, providing a unified interface that abstracts the complexity of memory operations from the AI agent 304. As shown in FIG. 3, the memory service 316 maintains bidirectional connections with multiple specialized data stores: the conversation history database 318, the moments database 320, and the trait system 322. This architecture enables the memory service 316 to function as an intelligent data broker that coordinates access to different types of conversational information while optimizing for performance, relevance, and context window utilization.

When an AI agent 304 requests conversation data, the memory service 316 performs a comprehensive retrieval operation across its connected data stores, assembling a unified payload that contains raw verbatim messages from the conversation history database 318, relevant semantic moments from the moments database 320, and applicable user traits from the trait system 322. This payload is returned to the AI agent in a single response, regardless of the total size, allowing the AI agent to make intelligent decisions about which elements to include in the prompt based on the available context window. The memory service implements caching mechanisms to reduce latency for frequently accessed conversation data, particularly important for voice-based interactions where response time is critical.

Consistent with some embodiments, the memory service 316 employs dual search capabilities when retrieving relevant historical information. For semantic searches, it leverages vector embeddings stored in the moments database 320 to identify contextually similar content based on meaning rather than exact keyword matches. Concurrently, it can perform lexical searches using traditional keyword-based indices to find precise term matches. The memory service 316 intelligently combines results from both search methodologies, providing the AI agent with the most relevant historical context regardless of how it was originally expressed. This hybrid approach is particularly valuable for long-running conversations where important context may have been discussed using different terminology at different times.

The integration between the memory service 316 and the trait system 322 enables personalized conversation experiences that persist across multiple interactions. The trait system 322 stores user-specific attributes and preferences that have been either explicitly provided by users or inferred from previous interaction and AI agent conversations. When the memory service 316 receives a request from the AI agent 304, it queries the trait system 322 to retrieve traits relevant to the current conversation context. These traits may originate from various sources, including the AI agent's own conversations, external customer data platforms, or other business systems. By incorporating this personalized information into the payload returned to the AI agent, the memory service enables more contextually appropriate and personalized responses.

The memory service 316 also implements channel-aware optimization strategies in coordination with the conversation router 308. For voice channels where latency is critical, the memory service may prioritize returning recent conversation history and high-confidence traits while limiting extensive searches for historical moments. For text-based channels with more relaxed latency requirements, it may perform more comprehensive retrieval operations, including deeper searches for relevant historical context. This channel-aware approach ensures optimal performance across different communication modalities while maintaining a consistent user experience.

Developers can configure the memory service 316 through the platform's development interface, allowing them to specify retention policies, prioritization rules for different types of conversation data, and integration parameters for external data sources. The memory service provides a consistent API that abstracts the underlying complexity of data storage and retrieval, enabling developers to focus on creating specialized AI agents without having to implement their own memory management solutions. This shared service approach allows multiple AI agents to benefit from memory handling capabilities without duplicating functionality, while still providing the flexibility for customization based on specific use cases.

### Trait System

The trait system 322 represents a component within the memory management architecture 300 shown in FIG. 3, designed to store, manage, and utilize user-specific information across multiple interactions and communication channels. As depicted in FIG. 3, the trait system 322 maintains a bidirectional connection with the memory service 316 and stores user traits in the traits database 324. This architecture enables the seamless integration of personalized user information into conversational AI interactions.

A “trait” in this context refers to a specific piece of contextual data associated with a user that can enhance the relevance and personalization of AI-generated responses. Traits are stored as key-value pairs with natural language labels (e.g., “age,” “address,” “shoe size,” “favorite_food”) rather than abstract identifiers, allowing the semantic meaning of the traits to be understood by language models when included in prompts. Examples of traits include personal preferences (“favorite_food”: “pancakes”), contact information (“email_address”: “example@example.com”), personal identifiers (“first_name”: “Dominik”, “last_name”: “Kundel”, “nickname”: “Dom”), security information (“gate_code”: “8842”), and sizing information (“shoe_size”: 11).

The trait system 322 integrates with the memory service 316 in two primary ways. First, during ongoing conversations, when a user provides information from which a trait can be derived, the memory service 316 works with the trait system 322 to update the traits database 324. For example, if a user states “I recently moved to 101 Spear St.” or “Dominik Kundel, but you can call me Dom” during a conversation, the system can extract this information and store it as traits associated with the user's unified customer profile. This extraction process may utilize the generative language model 314 to transform unstructured natural language into structured trait data.

Second, the trait system 322 works with the memory service 316 to analyze recent and historical messages to determine when particular traits should be included in prompts sent to the generative language model 306. When the AI agent 304 requests conversation data from the memory service 316, the service queries the trait system 322 for relevant traits based on the current conversation context. The trait system employs a specialized model to evaluate which traits from the user's profile would be most useful for the current conversation topic, ranking them by relevance. For example, if the conversation turns to footwear, the system might prioritize including the user's previously stored “shoe_size” trait in the prompt.

Traits may be derived through automated inference or explicitly specified by users. Inferred traits are extracted from conversations through natural language processing, where the system identifies statements that contain personal information or preferences. For example, when a user says, “I love Italian food,” the system can extract and store “favorite_cuisine”: “Italian” as a trait. Explicitly specified traits come directly from user-provided information, such as profile details submitted through forms or direct responses to questions (e.g., “What email should I use?” followed by “example@example.com”).

Importantly, traits are not limited to information derived within the AI agent system itself. The trait system 322 is designed to be loosely coupled with external data sources, allowing it to integrate with customer data platforms, user profiles, external databases, and other systems through which users provide information. This design enables the trait system to maintain a comprehensive understanding of user preferences and characteristics while providing a consistent abstraction layer for the AI agent 304 to access this information regardless of its original source.

The trait system 322 also implements a perception engine that can infer traits from user inputs in real-time and a personalization engine that determines which traits are relevant to the current conversation. When new traits are identified that conflict with existing ones (e.g., an updated address), the system can intelligently update the existing trait rather than creating redundant entries. This approach ensures that the user profile remains current and coherent across multiple interactions and channels.

Developers can configure the trait system 322 through the platform's development interface, allowing them to specify which types of traits should be extracted, how aggressively to infer traits, and how traits should be prioritized when included in prompts. This configurability enables developers to tailor the personalization capabilities of their AI agents to specific use cases and privacy requirements while leveraging the platform's trait management capabilities.

### Dynamic Prompt Generation Process

When a user sends a message from the user device 302, the AI agent 304 receives it through a communication channel identified by the conversation router 308. Upon receipt, the AI agent 304 initiates a comprehensive data retrieval process by making a single, unified call to the memory service 316. This call returns a complete payload containing the full conversation history from the conversation history database 318, semantically relevant moments from the moments database 320, and applicable user traits from the trait system 322. This comprehensive payload typically contains significantly more tokens than can fit within the available context window of the generative language model 306, necessitating token budget management by the AI agent 304.

Based on the available context window and channel-specific requirements, the AI agent 304 dynamically calculates and allocates a prompt budget through a token management algorithm. As illustrated in FIG. 4-A, this calculation considers multiple factors: the model's maximum context window size (e.g., 10,000 tokens), the tokens already used by system components (e.g., 2,000 tokens for system prompts), and the resulting available space (e.g., 8,000 tokens). The AI agent 304 then determines precisely how to distribute these available tokens between recent verbatim messages, summarized older content, and relevant historical moments. This allocation is not static but adapts dynamically based on multiple factors including the communication channel characteristics (e.g., voice versus text), model specifications, available external data sources (tools), and the current conversation state.

The AI agent 304 then executes a prompt assembly process, strategically selecting and organizing conversation history elements to fit within the allocated token budget. For recent interactions, the AI agent 304 typically prioritizes including verbatim messages to maintain immediate context fidelity. For older interactions, it incorporates summarized content that preserves essential information while consuming fewer tokens. Additionally, the AI agent 304 may include specific historical moments from the moments database 320 that are semantically relevant to the current conversation topic, even if they occurred much earlier in the conversation history. This intelligent selection process ensures that the most contextually important information is always available to the language model, regardless of how long the conversation has been ongoing or how many messages have been exchanged.

As the conversation progresses, the AI agent 304 may need to incorporate additional information from external data sources 326 through API calls or from tool responses. As shown in FIGS. 4-A and 4-B, when a function call (422) returns data (424) that consumes a portion of the available tokens (e.g., 2,000 tokens), the AI agent 304 immediately recalculates the token budget (428). This recalculation reduces the available space from 8,000 to 6,000 tokens, forcing the AI agent 304 to make strategic decisions about which conversation elements to retain, compress, or exclude. For example, it might reduce the number of verbatim messages from 5,500 to 4,200 tokens and the summarization from 2,000 to 1,700 tokens, resulting in a new conversation history allocation of 5,900 tokens. This dynamic adjustment continues with each additional tool call (430) and response (432), ensuring optimal context window utilization throughout the entire interaction process.

The AI agent 304 maintains this token budget management throughout multiple potential rounds of interaction with the generative language model 306 and external data sources 326. For each interaction, it recalculates the available token space and redistributes it optimally among system prompts, conversation history, and tool outputs. This process continues until the AI agent 304 has gathered all necessary information to generate a comprehensive response to the user's original query. Throughout this entire process, the complete conversation history remains preserved in the memory service 316, allowing the system to maintain conversation continuity across indefinitely long interactions while optimizing each specific prompt for the limited context window of the generative language model 306.

Concurrently with this dynamic prompt generation process, the conversation consumer 312 processes messages asynchronously from the conversations queue 310. It generates both summarized versions of conversation segments and vector embeddings that capture the semantic meaning of these conversations. These processed elements are stored in the conversation history database 318 and moments database 320 respectively, enabling more efficient retrieval of relevant historical context in future interactions. This parallel processing approach ensures that the system can maintain high performance even during extended conversations with multiple users across various communication channels.

### Token Budget Management Process

FIGS. 4-A and 4-B together illustrate a comprehensive sequence diagram depicting an example method for dynamically managing conversation history in an AI system, with a particular focus on optimizing token usage within a context window, according to some embodiments. This implementation demonstrates the token budget management capabilities of the system when handling complex, multi-turn conversations with external data retrieval requirements.

The sequence begins with an interaction between four key components shown at the top of FIG. 4-A: an end-user (client device) 402, an AI agent 404 with a system prompt consuming 2000 tokens, a memory service 406, and a tool use component 408 representing external resources such as APIs or database queries. In The airline example, the end-user 402 would be a frequent business traveler accessing the airline's AI agent through a mobile application.

### Conversation History Retrieval

The process initiates when the business traveler sends a new message 410 to the AI agent 404, stating: “I need to modify my upcoming Chicago trip. I'd like to extend my stay by two days and upgrade to business class if there are any reasonable options available.” Upon receiving this message, the initial context window 412 of the AI agent 404 shows a model limit of 10,000 tokens, with 2000 tokens already used by the system prompt 412-B (which includes the AI agent's personality, capabilities, and instructions for handling airline-related queries), leaving 8000 tokens available 412-A. At this stage, the conversation history is marked as “pending” as it has not yet been retrieved.

The AI agent 404 then sends a request 414 to the memory service 406 to retrieve the conversation history. This request includes the traveler's unique identifier and potentially channel information (mobile app versus voice call) to help the memory service prioritize relevant information. The memory service 406 responds with a full conversation history payload 416, which contains 12,000 tokens of historical data. This payload includes all previous interactions between the traveler and the airline's AI agent, such as past booking confirmations, previous trip modifications, seating preferences, frequent flyer status information, and any complaints or special requests made during previous trips.

### Dynamic Memory Token Calculation

Upon receiving this payload, the AI agent 404 performs a “Calculate Memory Tokens” operation 420. This calculation determines how to optimally allocate the available 8000 tokens given the full payload of 12,000 tokens. The AI agent analyzes the relevance of different conversation elements to the current query about modifying a Chicago trip. It prioritizes recent messages about the Chicago booking, previous interactions about flight changes, and any moments related to business class preferences. In this example, the system allocates 5500 tokens for recent verbatim messages (including the original booking confirmation and recent discussions about the Chicago trip) and 2000 tokens for summarized content (including past upgrade preferences and previous Chicago visits), totaling 7500 tokens for conversation history. This allocation is reflected in the updated context window 418, which now shows 7500 tokens dedicated to conversation history 418-A.

### Tool Call Integration

The AI agent 404 then makes a function call 422 to the tool use component 408, specifically calling the airline's reservation system API to retrieve current booking details for the Chicago trip, including flight numbers, current seat assignments, original booking class, and scheduled departure/return dates. The tool use component returns an output 424 that consumes 2000 tokens, containing detailed information about the traveler's current Chicago reservation, including confirmation codes, exact flight times, current fare class, and cancellation policies. This additional information is incorporated into the context window 426, reducing the available tokens from 8000 to 6000.

### Context Window Optimization

With this reduction in available tokens, the AI agent 404 performs another “Calculate Memory Tokens” operation 428, dynamically adjusting the allocation to fit within the new constraints. The AI agent strategically reduces the verbatim conversation history, keeping only the most immediately relevant messages about the Chicago trip while compressing older interactions. The allocation is reduced to 4200 tokens for messages and 1700 tokens for summary, totaling 5900 tokens for conversation history. This adjustment is reflected in the updated context window 426, which now shows 4000 tokens used (the original 2000 plus the 2000 from the tool output) and 6000 tokens available.

Continuing to FIG. 4-B, the AI agent 404 makes another function call 430 to the tool use component 408, this time querying the airline's availability system to check for business class upgrade options on the traveler's flights and potential extended stay dates. The system returns another output 432 consuming an additional 2000 tokens, containing detailed information about available business class seats, pricing for the upgrades, and hotel availability for the extended stay dates. This further reduces the available tokens in the context window.

The AI agent 404 performs a third “Calculate Memory Tokens” operation 436, further adjusting the allocation to fit within the now more constrained context window. The AI agent makes strategic decisions about which conversation elements to retain, prioritizing the most recent messages about the Chicago trip modification request and the current booking details, while further compressing historical information. The allocation is reduced to 2200 tokens for verbatim messages while maintaining 2000 tokens for summary content (which now includes condensed information about the traveler's upgrade preferences and loyalty status), totaling 4200 tokens for conversation history. This final adjustment is reflected in the updated context window 434, which now shows 5500 tokens used and 4500 tokens available.

### Practical Implementation Example

Finally, the AI agent 404 generates and sends a response 438 to the business traveler, stating: “I've checked your Chicago trip scheduled for May 15-18. I can extend your stay to May 20 as requested. For your flights, I found business class upgrade options available: your outbound flight (AA1234) has upgrades available for 25,000 miles or $450, and your return flight (now AA5678 on May 20) has upgrades for 30,000 miles or $520. Based on your previous preferences for using miles for domestic upgrades, would you like me to proceed with extending your stay and processing the upgrades using your available 60,000 frequent flyer miles?” This response incorporates all the relevant information retrieved from the external systems while maintaining the context of the traveler's history and preferences.

This sequence diagram effectively demonstrates the system's token budget management capabilities. Throughout the interaction, the AI agent maintains access to the traveler's complete conversation history in the memory service (12,000 tokens) while dynamically selecting the most relevant portions to include in each prompt based on the available context window space. As new information is added from the reservation system and availability queries, the system continuously recalculates and adjusts the token allocation, ensuring that the most contextually important information is preserved while staying within the model's token constraints.

The example illustrates how the system balances immediate context (the current trip modification request), relevant historical information (previous upgrade preferences), and external data (current booking details and availability) to provide a personalized and contextually appropriate response. This dynamic approach enables the airline's AI agent to maintain coherent, personalized conversations with travelers across multiple interactions and trip bookings, even as the conversation history grows beyond what could fit in a single context window.

In practice, the specific token allocations and adjustment strategies may vary based on additional factors. For instance, if the traveler were using a voice channel rather than the mobile app, the system might further prioritize recent messages and reduce historical context to minimize response latency. Similarly, if the traveler had an extensive history of complex interactions with the airline, the system might allocate more tokens to summarized content to preserve more historical context while staying within token limits.

### Software Architecture

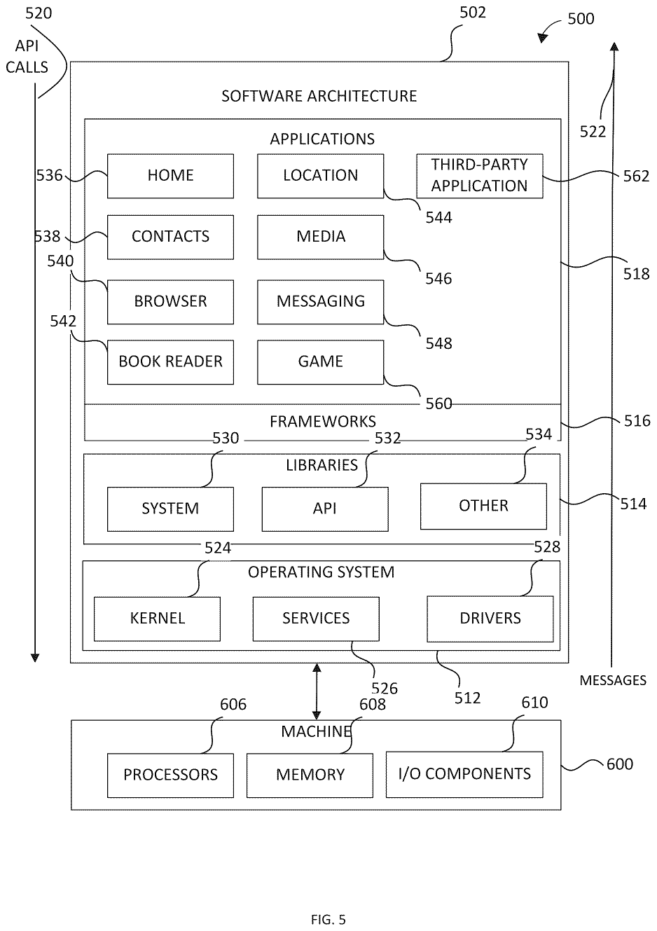

FIG. 5 is a block diagram 500 illustrating a software architecture 502, which can be installed on any one or more of the devices described herein. The software architecture 502 is supported by hardware such as a machine 604 that includes processors 606, memory 608, and I/O components 610. In this example, the software architecture 502 can be conceptualized as a stack of layers, where each layer provides a particular functionality. The software architecture 502 includes layers such as an operating system 512, libraries 514, frameworks 516, and applications 518. Operationally, the applications 518 invoke API calls 520 through the software stack and receive messages 522 in response to the API calls 520.

The operating system 512 manages hardware resources and provides common services. The operating system 512 includes, for example, a kernel 524, services 526, and drivers 528. The kernel 524 acts as an abstraction layer between the hardware and the other software layers. For example, the kernel 524 provides memory management, processor management (e.g., scheduling), component management, networking, and security settings, among other functionalities. The services 526 can provide other common services for the other software layers. The drivers 528 are responsible for controlling or interfacing with the underlying hardware. For instance, the drivers 528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 514 provide a common low-level infrastructure used by the applications 518. The libraries 514 can include system libraries 530 (e.g., C standard library) that provide functions such as memory allocation functions, string manipulation functions, mathematical functions, and the like. In addition, the libraries 514 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 514 can also include a wide variety of other libraries 534 to provide many other APIs to the applications 518.

The frameworks 516 provide a common high-level infrastructure that is used by the applications 518. For example, the frameworks 516 provide various graphical user interface (GUI) functions, high-level resource management, and high-level location services. The frameworks 516 can provide a broad spectrum of other APIs that can be used by the applications 518, some of which may be specific to a particular operating system or platform.

In an example, the applications 518 may include a home application 536, a contacts application 538, a browser application 540, a book reader application 542, a location application 544, a media application 546, a messaging application 548, a game application 550, and a broad assortment of other applications such as a third-party application 552. The applications 518 are programs that execute functions defined in the programs. Various programming languages can be employed to create one or more of the applications 518, structured in a variety of manners, such as object-oriented programming languages (e.g., Objective-C, Java, or C++) or procedural programming languages (e.g., C or assembly language). In a specific example, the third-party application 552 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 552 can invoke the API calls 520 provided by the operating system 512 to facilitate functionalities described herein.

### Machine Architecture

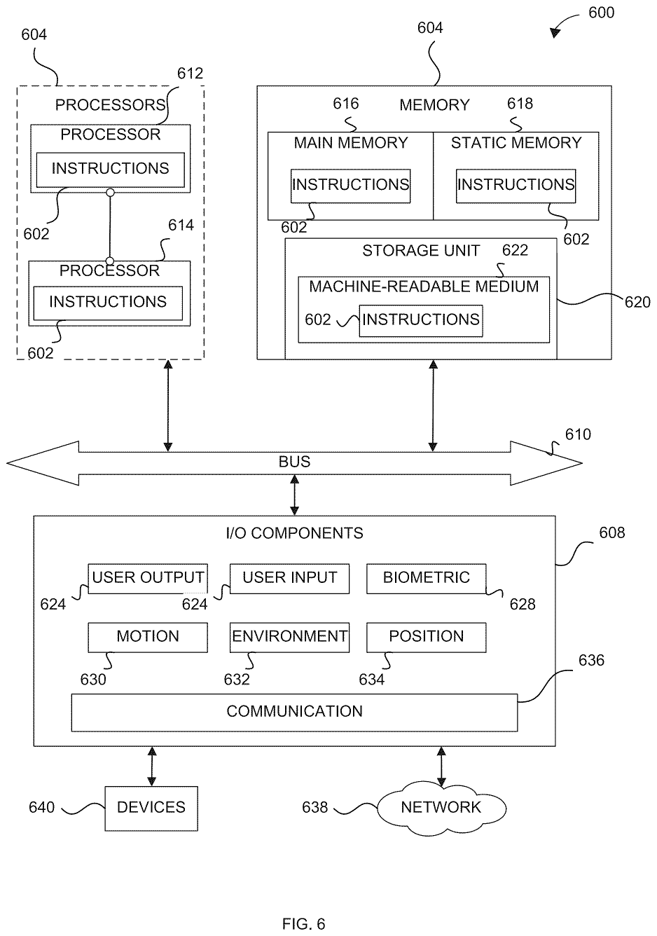

FIG. 6 is a diagrammatic representation of the machine 600 within which instructions 602 (e.g., software, a program, an application, an applet, an app, or other executable code) for causing the machine 600 to perform any one or more of the methodologies discussed herein may be executed. For example, the instructions 602 may cause the machine 600 to execute any one or more of the methods described herein. The instructions 602 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 602, sequentially or otherwise, that specify actions to be taken by the machine 600. Further, while a single machine 600 is illustrated, the term machine” shall also be taken to include a collection of machines that individually or jointly execute the instructions 602 to perform any one or more of the methodologies discussed herein. In some examples, the machine 600 may also comprise both client and server systems, with certain operations of a particular method or algorithm being performed on the server-side and with certain operations of the method or algorithm being performed on the client-side.

The machine 600 may include processors 604, memory 604, and input/output I/O components 608, which may be configured to communicate with each other via a bus 610.

The memory 606 includes a main memory 616, a static memory 618, and a storage unit 620, both accessible to the processors 604 via the bus 610. The main memory 606, the static memory 618, and storage unit 5620 store the instructions 602 embodying any one or more of the methodologies or functions described herein. The instructions 602 may also reside, completely or partially, within the main memory 616, within the static memory 618, within machine-readable medium 622 within the storage unit 620, within at least one of the processors 604 (e.g., within the processor's cache memory), or any suitable combination thereof, during execution thereof by the machine 600.

The I/O components 608 may include a wide variety of components to receive input, provide output, produce output, transmit information, exchange information, capture measurements, and so on. The specific I/O components 608 that are included in a particular machine will depend on the type of machine. For example, portable machines such as mobile phones may include a touch input device or other such input mechanisms, while a headless server machine will likely not include such a touch input device. It will be appreciated that the I/O components 608 may include many other components that are not shown in FIG. 6. In various examples, the I/O components 608 may include user output components 624 and user input components 626. The user output components 624 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 626 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 630 include acceleration sensor components (e.g., accelerometer), gravitation sensor components, rotation sensor components (e.g., gyroscope).

The environmental components 632 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 636 may detect identifiers or include components operable to detect identifiers. For example, the communication components 636 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 636, such as location via Internet Protocol (IP) geolocation, location via Wi-Fi® signal triangulation, location via detecting an NFC beacon signal that may indicate a particular location, and so forth.

The various memories (e.g., main memory 616, static memory 618, and memory of the processors 604) and storage unit 620 may store one or more sets of instructions and data structures (e.g., software) embodying or used by any one or more of the methodologies or functions described herein. These instructions (e.g., the instructions 602), when executed by processors 604, cause various operations to implement the disclosed examples.

The instructions 602 may be transmitted or received over the network 638, using a transmission medium, via a network interface device (e.g., a network interface component included in the communication components 636) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 640.

What is claimed is:

1. A system comprising:
one or more computer processors;
one or more computer memories;
a set of instructions incorporated into the one or more computer memories, the set of instructions configuring the one or more computer processors to perform operations, the operations comprising:
receiving, by an AI agent, a user message and retrieving a full conversation history payload from a memory service, wherein the full conversation history payload includes one or more messages, summaries, or moments;
dynamically allocating, by the AI agent, a prompt budget based on an available context window, wherein the prompt budget determines token allocations for the messages, summaries, or moments from the full conversation history payload;
assembling, by the AI agent, a prompt for a language model by selecting conversation history elements to fit within the allocated prompt budget, wherein the selecting balances between recent verbatim messages, summarized content of older messages, and relevant older moments; and
iteratively adjusting the prompt budget and reassembling the prompt as new information is added from one or more language model outputs or tool calls, while maintaining the full conversation history payload in the memory service.

2. The system of claim 1, wherein the moments include conversation metadata in text or audio that is typically outside of immediate or recent conversation history.

3. The system of claim 1, wherein the moments are discovered by querying one or more databases using a semantic or lexical search.

4. The system of claim 1, wherein selecting conversation history elements includes determining whether to include the moments based on a communication channel, with voice channels prioritizing low-latency responses by foregoing extensive searches for moments, and text-based channels allowing for inclusion of moments through asynchronous processing.

5. The system of claim 1, wherein the iterative adjustment of the prompt budget and reassembling of the prompt further comprises:
receiving, by the AI agent, a request from the language model to use a tool;
executing one or more tool calls, wherein the tool comprises an API call, a lexical search of a database, or a semantic search of a database; and
incorporating the output of the tool call into the prompt, wherein the incorporation reduces the available token budget for conversation history elements;

6. The system of claim 5, wherein the iterative adjustment of the prompt budget and reassembling of the prompt further comprises:
dynamically recalculating the prompt budget based on the reduced available tokens; and
reassembling the prompt by adjusting the balance between recent verbatim messages, summarized content, and relevant moments to fit within the recalculated prompt budget.

7. The system of claim 1, the operations further comprising:
determining a communication channel type for the user message; and
adjusting the prompt budget allocation based on the determined channel type.

8. A method comprising:
receiving, by an AI agent, a user message and retrieving a full conversation history payload from a memory service, wherein the full conversation history payload includes one or more messages, summaries, or moments;
dynamically allocating, by the AI agent, a prompt budget based on an available context window, wherein the prompt budget determines token allocations for the messages, summaries, or moments from the full conversation history payload;
assembling, by the AI agent, a prompt for a language model by selecting conversation history elements to fit within the allocated prompt budget, wherein the selecting balances between recent verbatim messages, summarized content of older messages, and relevant older moments; and
iteratively adjusting the prompt budget and reassembling the prompt as new information is added from one or more language model outputs or tool calls, while maintaining the full conversation history payload in the memory service.

9. The method of claim 8, wherein the moments include conversation metadata in text or audio that is typically outside of immediate or recent conversation history.

10. The method of claim 8, wherein the moments are discovered by querying one or more databases using a semantic or lexical search.

11. The method of claim 8, wherein selecting conversation history elements includes determining whether to include the moments based on a communication channel, with voice channels prioritizing low-latency responses by foregoing extensive searches for moments, and text-based channels allowing for inclusion of moments through asynchronous processing.

12. The method of claim 8, wherein the iterative adjustment of the prompt budget and reassembling of the prompt further comprises:
receiving, by the AI agent, a request from the language model to use a tool;
executing the one or more tool call, wherein the tool comprises an API call, a lexical search of a database, or a semantic search of a database; and
incorporating the output of the tool call into the prompt, wherein the incorporation reduces the available token budget for conversation history elements;

13. The method of claim 12, wherein the iterative adjustment of the prompt budget and reassembling of the prompt further comprises:
dynamically recalculating the prompt budget based on the reduced available tokens; and
reassembling the prompt by adjusting the balance between recent verbatim messages, summarized content, and relevant moments to fit within the recalculated prompt budget.

14. The method of claim 8, the operations further comprising:
determining a communication channel type for the user message; and
adjusting the prompt budget allocation based on the determined channel type.

15. A non-transitory computer-readable storage medium storing a set of instructions that, when executed by one or more computer processors, performs one or more operations, the operations comprising:
receiving, by an AI agent, a user message and retrieving a full conversation history payload from a memory service, wherein the full conversation history payload includes one or more messages, summaries, or moments;
dynamically allocating, by the AI agent, a prompt budget based on an available context window, wherein the prompt budget determines token allocations for the messages, summaries, or moments from the full conversation history payload;
assembling, by the AI agent, a prompt for a language model by selecting conversation history elements to fit within the allocated prompt budget, wherein the selecting balances between recent verbatim messages, summarized content of older messages, and relevant older moments; and
iteratively adjusting the prompt budget and reassembling the prompt as new information is added from one or more language model outputs or tool calls, while maintaining the full conversation history payload in the memory service.

16. The non-transitory computer-readable storage medium of claim 15, wherein the moments include conversation metadata in text or audio that is typically outside of immediate or recent conversation history.

17. The non-transitory computer-readable storage medium of claim 15, wherein the moments are discovered by querying one or more databases using a semantic or lexical search.

18. The non-transitory computer-readable storage medium of claim 15, wherein selecting conversation history elements includes determining whether to include the moments based on a communication channel, with voice channels prioritizing low-latency responses by foregoing extensive searches for moments, and text-based channels allowing for inclusion of moments through asynchronous processing.

19. The non-transitory computer-readable storage medium of claim 15, wherein the iterative adjustment of the prompt budget and reassembling of the prompt further comprises:
receiving, by the AI agent, a request from the language model to use a tool;
executing the one or more tool call, wherein the tool comprises an API call, a lexical search of a database, or a semantic search of a database; and
incorporating the output of the tool call into the prompt, wherein the incorporation reduces the available token budget for conversation history elements.

20. The non-transitory computer-readable storage medium of claim 19, wherein the iterative adjustment of the prompt budget and reassembling of the prompt further comprises:
dynamically recalculating the prompt budget based on the reduced available tokens; and
reassembling the prompt by adjusting the balance between recent verbatim messages, summarized content, and relevant moments to fit within the recalculated prompt budget.
